(19) United States
(12) Patent Application Publication
(10) Pub. No.: US 2012/0254870 A1
(43) Pub. Date: Oct. 4, 2012

(54) INFORMATION PROCESSING APPARATUS, WORKFLOW SETTING METHOD, AND PROGRAM THEREFOR

(75) Inventor: Masaaki Sato, Yokohama-shi (JP)

(73) Assignee: CANON KABUSHIKI KAISHA, Tokyo (JP)

(21) Appl. No.: 13/408,718

(22) Filed: Feb. 29, 2012

(30) Foreign Application Priority Data
Mar. 29, 2011 (JP) 2011-072248

(51) Int. Cl. G06F 9/46

(52) U.S. Cl. 718/100

(57) ABSTRACT

The present invention is directed to facilitation of setting of workflow parameter values by storing a parameter value corresponding to a parameter used in processing in a process mode identified by definition information in association with parameter and information of a communication regulation as parameter information into a memory unit, from setting information of a workflow including information of the communication regulation with a cooperation apparatus, information of the process mode of the workflow, parameters in the processing in the process mode, and parameter values of the parameters.

### BACKGROUND OF THE INVENTION

1. Field of the Invention

The present invention relates to an information processing apparatus, a workflow setting method, and a program therefor.

2. Description of the Related Art

In recent years, multifunction peripherals have been developed as multifunction apparatuses that individually combine the functions of a printer, a copier, a facsimile, and the like. In addition, multifunction peripherals that can execute a plurality of processes as one job have increased to simplify users' work at their offices. The work may involve various processes. In the multifunction peripheral, arbitrary processes can be combined from among the processes such as scan processing, image processing to extract characters from an image, and transmission processing to transmit scanned data to an external system, and the combination can be defined the as a workflow. Further, such a workflow can be registered in the multifunction peripheral. For example, a workflow can assign a multifunction peripheral to perform scan processing and a client computer to perform image processing and data transmission processing to an external system. In other words, multifunction peripherals can create and implement a workflow so that the multifunction peripheral and the client computer are each assigned to perform processing as specified in the workflow.

When a user instructs the multifunction peripheral to implement the workflow registered therein, the user can obtain the implementation result of a series of processes. The implementation of the registered workflow has become more common as a way to enhance work efficiency. On the other hand, external systems generally provide a plurality of cooperation modes, so that different cooperation modes can be used for different workflows. According to Japanese Patent Application Laid-Open No. 2000-270148, examples of the cooperation modes include:

(1) a mode in which values of all parameters are set and transmitted in advance; and
(2) a mode in which values of certain parameters are displayed to a user, and the parameter values are transmitted interactively.

However, when workflows that each utilize a plurality of cooperation modes are created, even if the workflows use the same destination (i.e., an external system), initial values (i.e., parameter values) need to be manually input for each workflow to save later input operation, which is complicated.

### SUMMARY OF THE INVENTION

The present invention is directed to providing a system to set parameter values of a workflow.

According to an aspect of the present invention, an information processing apparatus including a memory unit that stores a communication regulation for executing processing for a workflow in cooperation with a cooperation apparatus and definition information that includes definitions of parameters to be used in processing in each of process modes of the workflow, The information processing apparatus includes a storage unit configured to store a parameter value corresponding to a parameter used in the processing in the process mode identified by the definition information in association with the parameter and information of the communication regulation as parameter information into the memory unit, from setting information of the workflow that includes the information of the communication regulation with the cooperation apparatus, information of the process modes of the workflow, parameters used in the processing in the process mode, and parameter values of the parameters, and a setting unit configured to, when the workflow starts, read out parameter information in the information of the communication regulation that matches the information of the communication regulation in the setting information of the workflow from the memory unit, and to set a parameter value of the parameter information to a parameter of the setting information corresponding to the parameter of the read parameter information.

According to the present invention, setting of parameter values of a workflow can be facilitated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a workflow processing system.

FIG. 2 illustrates an example of a hardware configuration of a control apparatus in a multifunction peripheral.

FIG. 3 illustrates an example of a hardware configuration of a scanner and a printer.

FIG. 4 illustrates an example of a configuration of an operation unit.

FIG. 5 illustrates an example of an operation screen.

FIG. 6 illustrates an example of a module configuration of a controller unit.

FIG. 7 illustrates examples of information pieces about cooperation modes.

FIG. 8 illustrates an example of a table for managing storing target information.

FIG. 9 illustrates an example of a table for managing diversion target information.

FIG. 10 illustrates an example of a flowchart for a storing process.

FIG. 11 illustrates an example of a flowchart for a creating process.

FIG. 12 illustrates an example of a flowchart for an obtaining process.

FIG. 13 illustrates an example of a workflow.

FIG. 14 illustrates an example of a workflow.

FIG. 15 illustrates an example of a workflow.

FIG. 16 illustrates an example of a flowchart for a storing process.

FIG. 17 illustrates an example of a table for managing storing target information.

FIG. 18 illustrates an example of a table for managing diversion target information.

FIG. 19 illustrates an example of a table for managing diversion target information.

### DESCRIPTION OF THE EMBODIMENTS

Various exemplary embodiments, features, and aspects of the invention will be described in detail below with reference to the drawings.

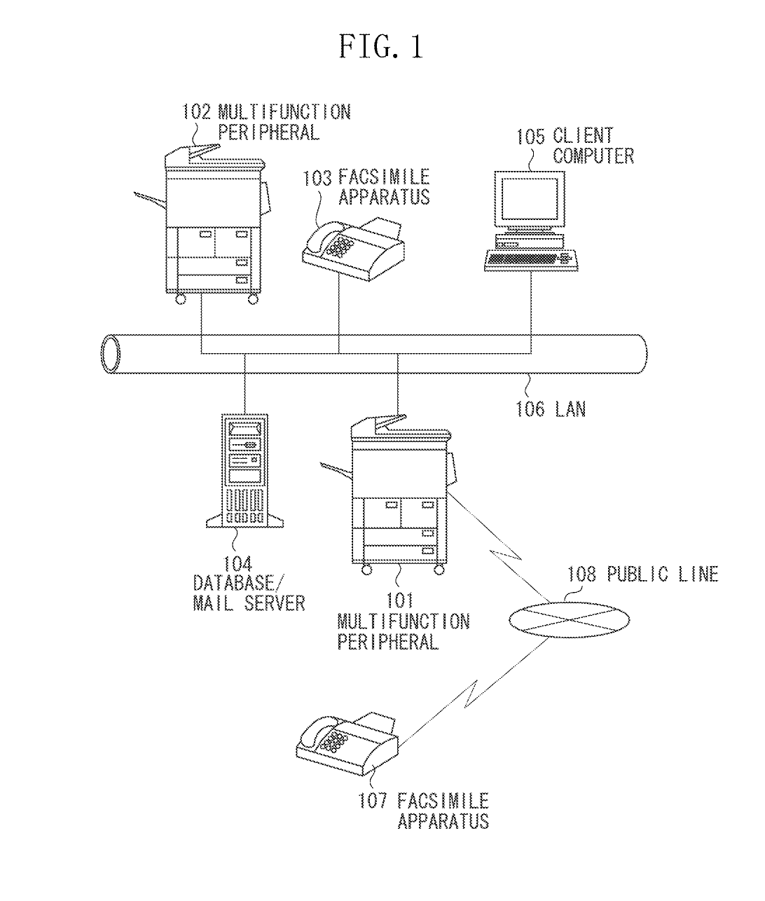

FIG. 1 illustrates an example of a configuration of a workflow processing system according to a first exemplary embodiment. The workflow processing system may include a plurality of types of apparatuses (including computers). The plurality of types of apparatuses is mutually connected via various networks.

More specifically, in the workflow processing system, a multifunction peripheral 101, a multifunction peripheral 102, a facsimile apparatus 103, a database/mail server 104, and a client computer 105 are connected so as to be able to communicate with each other via a local area network (LAN) 106. In the workflow processing system, the multifunction peripheral 101 is also communicably connected to a facsimile apparatus 107 via a public line 108.

The multifunction peripheral 101 is provided with a copy function, a facsimile function, a data transmission function, which reads a document and transmits the read image data to apparatuses on the LAN 106, print function, and so on. For example, the multifunction peripheral 101 receives Page Description Language (PDL) data instructed by an apparatus connected to the LAN 106, and prints the data.

Further, for example, the multifunction peripheral 101 stores data into a below-described box area in the multifunction peripheral 101. Examples of the data include the one read by the multifunction peripheral 101 and PDL data instructed by the apparatus connected to the LAN 106, for example. The multifunction peripheral 101 can print the data stored in the box area. The multifunction peripheral 101 receives, via the LAN 106, data read by the multifunction peripheral 102, and stores the data into a below-described hard disk drive (HDD) 204 in the multifunction peripheral 101. The received data also can be printed by the multifunction peripheral 101. The multifunction peripheral 101 responds to an instruction from the client computer 105 to receive data transmitted from the database/mail server 104 via the LAN 106, and stores the data into the HDD 204 in the multifunction peripheral 101. The received data also can be printed by the multifunction peripheral 101.

The facsimile apparatus 103 receives data read by the multifunction peripheral 101, and transmits the data to another apparatus via the LAN 106. The received data also can be printed by the facsimile apparatus 103. The database/mail server 104 is an example of an information processing apparatus (i.e., a computer). The database/mail server 104 receives, via the LAN 106, data read by the multifunction peripheral 101, and stores the received data as a database. The received data also can be transmitted as an e-mail by the database/mail server 104.

The client computer 105 is an example of an information processing apparatus (i.e., a computer). The client computer 105 is connected to the database/mail server 104 to obtain desired data from the database/mail server 104 and to display it. The client computer 105 receives, via the LAN 106, data read by the multifunction peripheral 101, and processes and edits the received data. The facsimile apparatus 107 receives, via the public line 108, data read by the multifunction peripheral 101, and prints the received data. The multifunction peripheral 102 is provided with the same functions as those of the multifunction peripheral 101, which will not be described.

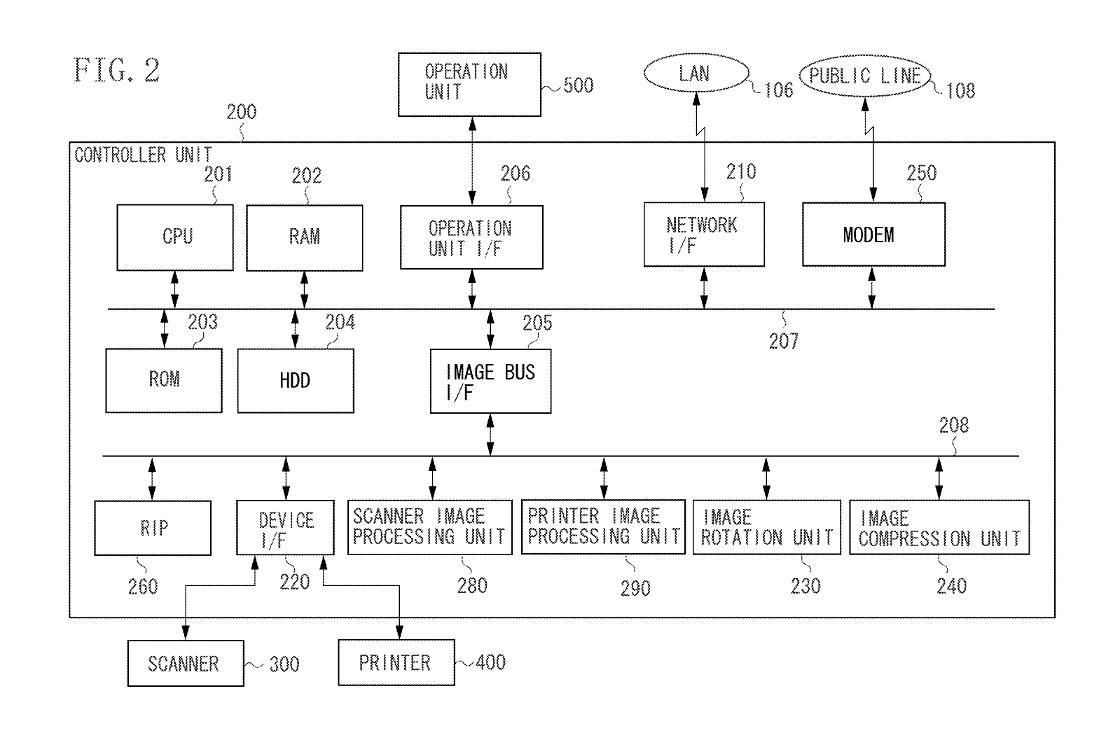

FIG. 2 illustrates an example of a hardware configuration of a control apparatus (i.e., a controller unit 200) in the multifunction peripheral 101. The controller unit 200 is an example of an information processing apparatus (i.e., a computer). The controller unit 200 is connected to a scanner 300 as an example of an image input device, a printer 400 as an example of an image output device, and an operation unit 500 as an example of an information input/output device. The controller unit 200 controls each device so that an image read by the scanner 300 can be printed by the printer 400. The controller unit 200 is connected to a network (for example, the LAN 106, and a wide area network (WAN) such as the public line 108), and controls each device so that the image and information such as device information can be input/output.

A central processing unit (CPU) 201 executes a boot program stored in a read only memory (ROM) 203 to start up an operation system (OS). An application program stored in the hard disk drive (HDD) 204 is executed on the OS, so that various processes can be performed. In other words, the CPU 201 performs processing according to procedures of the program stored in the ROM 203 and the HDD 204, so that the functions of the multifunction peripheral 101 and processes in below-described flowcharts are realized.

A random access memory (RAM) 202 is used as a work area for the CPU 201. In addition to the work area, the RAM 202 provides an image memory area for temporarily storing images (image data). The HDD 204 stores application programs and image data, for example.

The CPU 201 is connected via a system bus 207 to the RAM 202, the ROM 203, the HDD 204, an operation unit interface (I/F) 206, a network I/F 210, a modem 250, and an image bus I/F 205. The operation unit I/F 206 is an interface for the operation unit 500 including a touch panel, and outputs image data to the operation unit 500 to be displayed there. The operation unit I/F 206 notifies the CPU 201 of information (data) input by a user at the operation unit 500.

The network I/F 210 is connected to the LAN 106 to transmit and receive (output/input) data via the LAN 106 to and from apparatuses connected to the LAN 106. The modem 250 is connected to the public line 108 to transmit and receive (output/input) data via the public line 108 to and from the facsimile apparatus 107.

The image bus I/F 205 is a bus bridge that connects the system bus 207 to an image bus 208 for high-speed transfer of image data and that converts formats of data. The image bus 208 is connected to a raster image processor (RIP) 260, a device I/F 220, a scanner image processing unit 280, a printer image processing unit 290, an image rotation unit 230, and an image compression unit 240. The image bus 208 may be a Peripheral Component Interconnect (PCI) bus, or a bus conforming to the Institute of Electrical and Electronics Engineers (IEEE) 1394 standard, for example.

The RIP 260 is a processor that rasterizes PDL data (code) into a bitmap image. The device I/F 220 is connected to the scanner 300 and the printer 400. The device I/F 220 performs synchronous/asynchronous conversion of image data.

The scanner image processing unit 280 corrects, processes, and edits the image data input thereto. The printer image processing unit 290 performs correction and resolution conversion on image data to be printed (output for printing), in correspondence to the printer 400. The image rotation unit 230 rotates image data. The image compression unit 240 compresses multivalued image data into Joint Photographic Experts Group (JPEG) data, and compresses binarized image data into data in a format such as Joint Bi-level Image Experts Group (JBIG), Modified Modified Read (MMR), and Modified Huffman (MH), and executes their decompression processing.

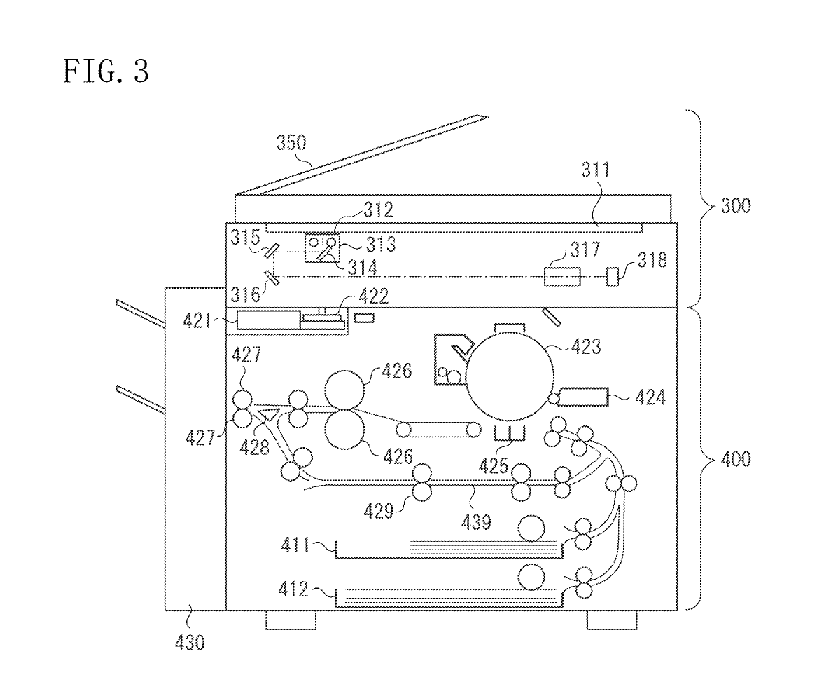

The scanner 300 and the printer 400 are described with reference to FIG. 3. FIG. 3 illustrates an example of a hardware configuration of the scanner 300 and the printer 400. As illustrated in FIG. 3, the scanner 300 is integrally formed with the printer 400.

The scanner 300 is provided with a document feeding unit 350. The document feeding unit 350 feeds document sheets one by one from the top of a stack onto a platen glass 311. The document feeding unit 350 discharges the document sheet in sequence from the platen glass 311 to a discharge tray (not illustrated) every time when reading of each document sheet is completed.

The scanner 300 turns on a lamp 312 when the document sheet is fed on the platen glass 311, and starts to move a movable unit 313. As the movable unit 313 moves, the document on the platen glass 311 is scanned for reading. During the scan reading, the light reflected by the document is lead to a charge coupled device (CCD) image sensor (CCD) 318 via mirrors 314, 315, and 316 and a lens 317. The light is focused on an imaging plane of the CCD 318 to form an image of the document there. The CCD 318 converts the image formed on the imaging plane into electrical signals. The electrical signals are subjected to a predetermined process to be input into the control apparatus (i.e., controller unit 200).

The printer 400 includes a laser driver 421. The laser driver 421 drives a laser emission unit 422 based on image data input from the control apparatus. The laser emission unit 422 then emits a laser beam according to the image data. The laser beam illuminates a photosensitive drum 423 while scanning. An electrostatic latent image is formed by the illuminated laser beam onto the photosensitive drum 423. The formed electrostatic latent image is visualized as a toner image by toner supplied from a development device 424.

Synchronized with the illumination of the laser beam, a recording sheet as a recording medium is fed from one of cassettes 411 and 412 to between the photosensitive drum 423 and a transfer unit 425 through a conveyance path. The toner image on the photosensitive drum 423 is transferred onto the fed recording sheet by the transfer unit 425.

The recording sheet having the toner image transferred thereon is fed to a fixing roller pair (i.e., a heating roller and a pressure roller) 426 by a conveyor belt. The fixing roller pair 426 presses and heats the recording sheet to fix the toner image onto the recording sheet. The recording sheet, after passing the fixing roller pair 426, is discharged to a sheet discharge unit 430 by a discharge roller pair 427. The sheet discharge unit 430 includes a sheet processing apparatus that can applies post-processing such as sorting and stapling to the recording sheets.

For printing of both sides of the recording sheet, the printer 400 conveys the recording sheet to the discharge roller pair 427, reverses the rotation direction of the discharge roller pair 427, and uses a flapper 428 to lead the recording sheet to a re-feed conveyance path 439. The recording sheet led to the re-feed conveyance path 439 is fed again between the photosensitive drum 423 and the transfer unit 425 at the above-described timing, so that a toner image is transferred to the back side of the recording sheet.

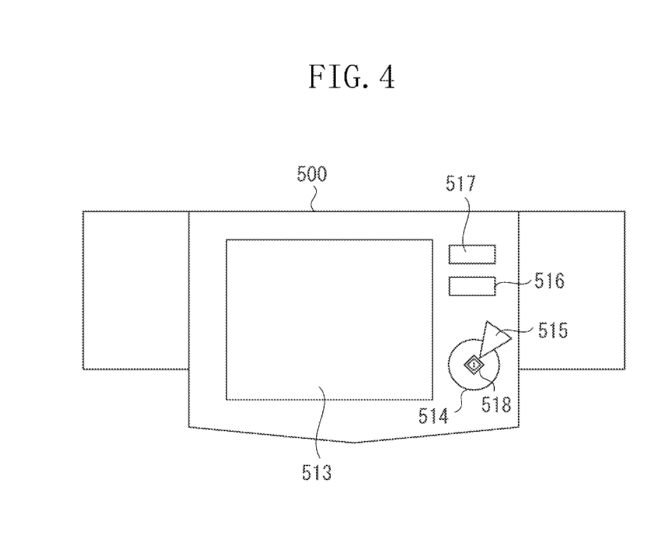

FIG. 4 illustrates an example of a configuration of the operation unit 500. A liquid crystal display (LCD) display unit 513 includes an LCD having a touch panel sheet stuck thereon. The LCD display unit 513 displays an operation screen of the multifunction peripheral 101, and also notifies the CPU 201 in the controller unit 200 (by input) of a positional information of a touch key (which is an example of a user interface) when the touch key displayed on the operation screen is pressed.

A start key 514 is operated to start reading of a document. The start key 514 includes two-color (green and read) light-emitting diode (LED) 518 centrally thereof, so that the colors indicate whether the start key 514 is ready to use or not. A stop key 515 is operated to stop an operation currently running. An identification (ID) key 516 is operated to input a user ID. A reset key 517 is operated to initialize information input from the operation unit 500 (e.g., an operation screen).

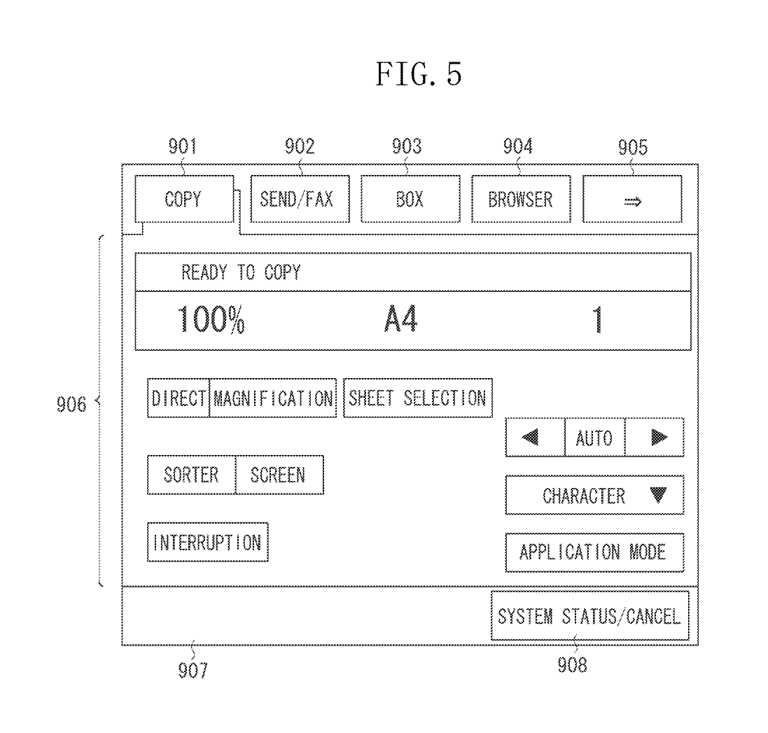

FIG. 5 illustrates an example of an operation screen displayed on the LCD display unit 513 of the operation unit 500. The operation screen includes touch keys at the upper part for enabling the user to select a function to use from among the functions provided to the multifunction peripheral 101. The illustrated touch keys include a copy tab 901, a send/FAX tab 902, a box tab 903, a browser tab 904, and a right arrow tab 905. FIG. 5 illustrates an initial screen when the touch key of the copy tab 901 is pressed.

The display about the copy function is included in an area 906 of the operation screen. The area 906 includes a smaller area indicating “ready to copy” to display a status of the copy function. Below the indication “ready to copy”, a magnification ratio, a selected sheet feeding stage, and the number of copies to be made are displayed. The area 906 also displays, as touch keys for setting an operation mode of the copy function, a direct tab, a magnification tab, a sheet selection tab, a sorter tab, a two-sided tab, an interruption tab, a character tab, a left arrow key to adjust density by decreasing, a right arrow key to adjust density by increasing, and an auto key to automatically adjust density. An application mode key is also provided, so that, upon a press down of the application mode key, a screen is displayed in a hierarchical way within the area 906 to set additional operation modes that cannot be displayed on the initial screen.

An area 907 within the operation screen displays a status of the multifunction peripheral 101. For example, the area 907 displays an alarm message indicating sheet jam, and a status message indicating an on-going print process while PDL data is being printed. The area 907 also displays a system status/cancel touch key 908. Upon a press down of the system status/cancel touch key 908, the multifunction peripheral 101 displays a screen for displaying device information of the multifunction peripheral 101, and a screen (not illustrated) for displaying the state of an on-going print job, for example. Through the screen displayed then, the job can be cancelled.

Upon a press down of the send/FAX tab 902, the multifunction peripheral 101 displays a screen through which the user can input an instruction to transmit an image read by the multifunction peripheral 101 by E-mail or File Transfer Protocol (FTP) to an apparatus connected to the LAN 106 or by a facsimile via the public line 108. Upon a press down of the box tab 903, the multifunction peripheral 101 displays a screen through which an image read by the multifunction peripheral 101 can be stored in a box area of the HDD 204, and an image stored in the box area can be specified to be printed or transmitted to an apparatus on the LAN 106. In the case where the multifunction peripheral 101 is provided with five or more functions, the right arrow tab 905 is displayed on the right side of the other four function tabs 901 to 904, so that, upon a press down of the right arrow tab 905, a screen is displayed with the fifth and subsequent functions (other than the four functions).

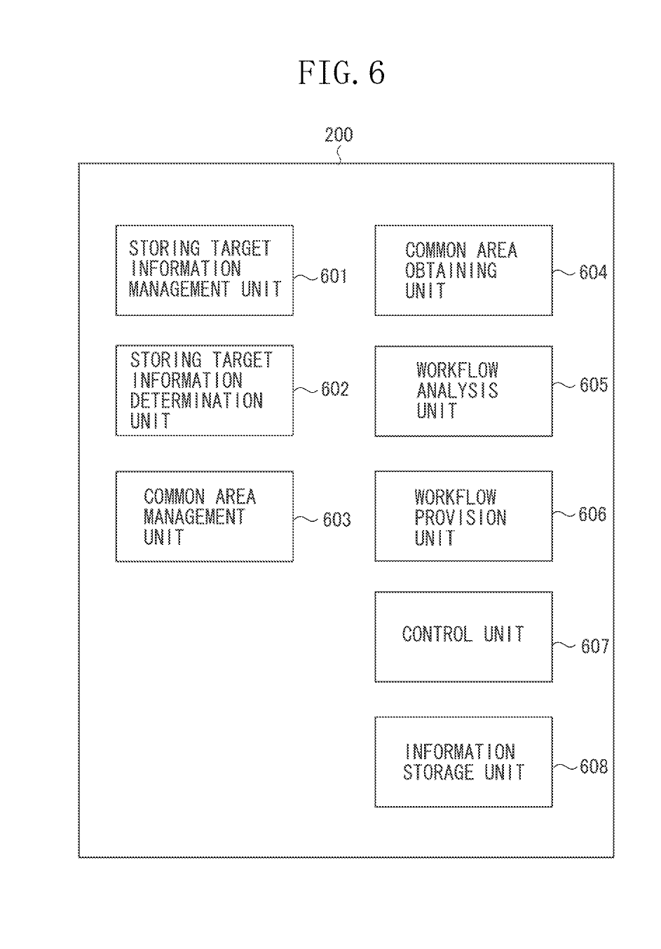

FIG. 6 illustrates an example of a module configuration of the controller unit 200. A storing target information management unit 601 manages and provides storing target information for identifying target information to be stored into the multifunction peripheral 101 from among information pieces (set values) set in a workflow. The term herein “workflow” defines a process flow performed by the multifunction peripheral 101 in cooperation with other apparatuses.

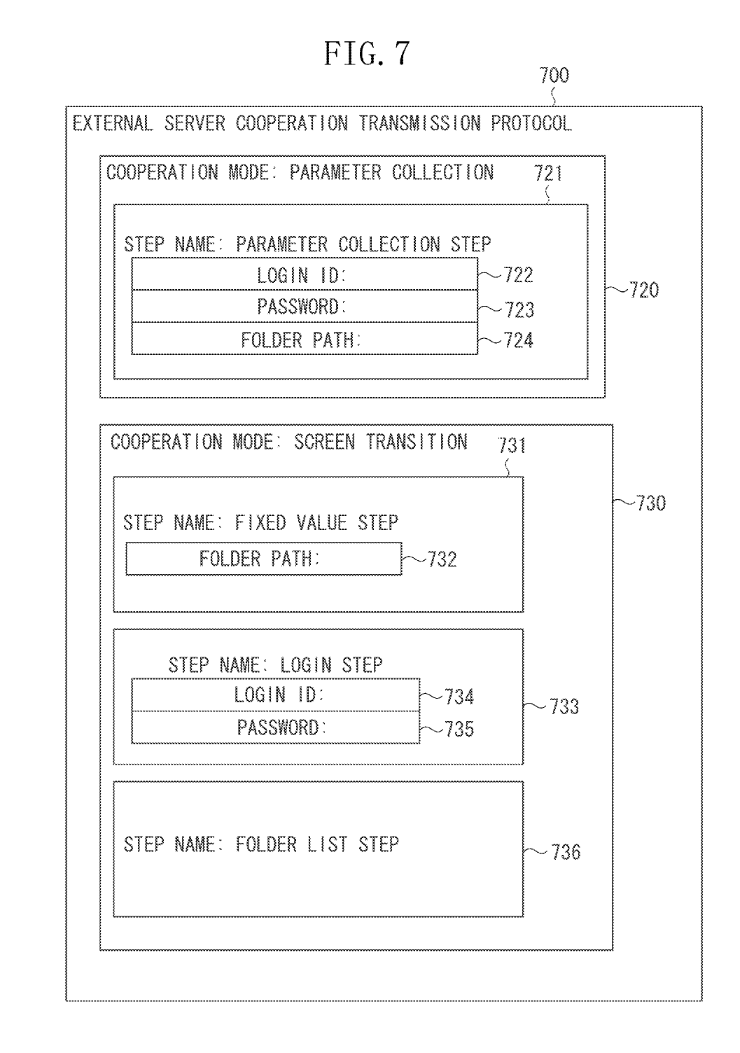

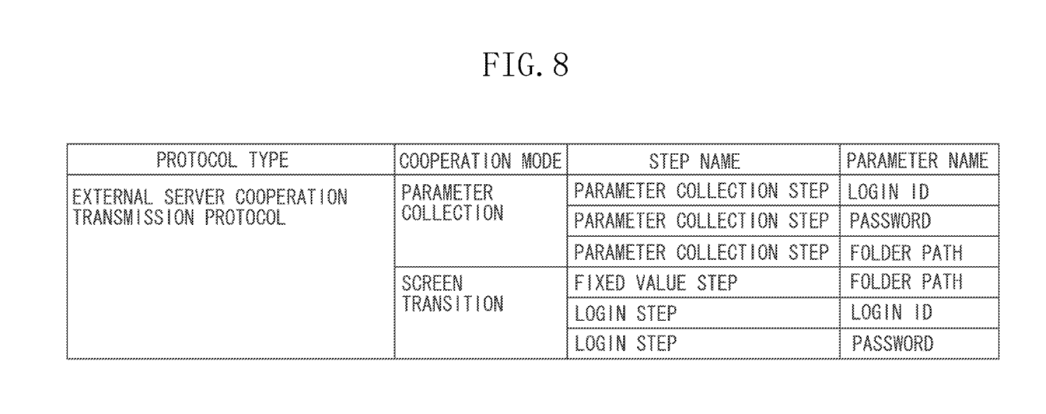

The other apparatuses each use a protocol for communication as a communication regulation. For example, the multifunction peripheral 101 communicates with an external server such as the database/mail server 104 using an external server cooperation transmission protocol such as Server Message Block (SMB). The communication using the external server cooperation transmission protocol can be used in various cooperation modes (i.e., examples of process modes). In the present exemplary embodiment, a parameter collection cooperation mode and a screen transition cooperation mode are described as examples of the modes. The cooperation mode is described below in detail with reference to FIG. 7. The storing target information is described below in detail with reference to FIG. 8.

A storing target information determination unit 602 determines whether the set values of the workflow are targets to be stored or not, based on the storing target information managed by the storing target information management unit 601. A common area management unit 603 stores the set values of the workflow that are determined as the targets to be stored by the storing target information determination unit 602 into a common area of the HDD 204 and manages them as diversion target information (that is an example of parameter information).

A common area obtaining unit 604 obtains a list of diversion target information from the common area managed by the common area management unit 603. The list of diversion target information obtained by the common area obtaining unit 604 is displayed in a selectable form, so that a user can select (specify) pieces of the diversion target information.

When the workflow is specified, a workflow analysis unit 605 analyzes the workflow, the set information of the workflow in a broader sense, and obtains the set values of the workflow. A workflow provision unit 606 applies the value of a specified diversion target to the workflow instructed to be implemented, and provides the workflow. A control unit 607 controls and calls various modules 601 to 606 and 608. An information storage unit 608 may be a database, and stores information necessary for the HDD 204.

FIG. 7 illustrates an example of information pieces about cooperation modes. As examples of cooperation modes in a server cooperating transmission protocol 700, two cooperation modes, that is, a parameter collection cooperation mode 720 and a screen transition cooperation mode 730, are described, but other cooperation modes may be used. Since the information about the cooperation modes is disclosed to an external server, a user can switch the cooperation modes from among the plurality of the cooperation modes to use a workflow.

In the parameter collection cooperation mode 720, a parameter collection step 721 is performed by the external server. In the parameter collection step 721, information pieces of a login ID 722, a password 723, and a folder path 724 are used. For a workflow in the parameter collection cooperation mode 720, a user applies the information pieces of the login ID 722, the password 723, and the folder path 724 (which are examples of parameters) to the workflow. When the multifunction peripheral 101 instructs start of the workflow having the set values, the input screen for the values necessary in the parameter collection step 721 is not displayed.

In the screen transition cooperation mode 730, a fixed value step 731, a login step 733, and a folder list step 736 are performed by the external server. In the fixed value step 731, the information piece of a folder path 732 is used. In the login step 733, the information pieces of a login ID 734 and a password 735 are used. For a workflow in the screen transition cooperation mode 730, a user applies the information pieces of the folder path 732, the login ID 734, and the password 735 to the workflow. When the multifunction peripheral 101 instructs start of the workflow having the set values, the input screen for the values necessary in the fixed value step 731, the login step 733, and the folder list step 736 is displayed with the values reflected thereon. In other words, the set values of the workflow in the screen transition cooperation mode 730 are provided as input assistances that allow a user to edit them when the workflow is implemented.

FIG. 8 illustrates an example of a table used by the storing target information management unit 601 to manage storing target information. The storing target information management unit 601 manages and provides the storing target information by each of the protocol types and the cooperation modes. The storing target information is an example piece of definition information that defines a combination of a step name and a parameter name (which are examples of the parameters) to be used in a process in each cooperation mode (i.e., each process mode). The storing target information is stored in a table for each protocol type and each cooperation mode.

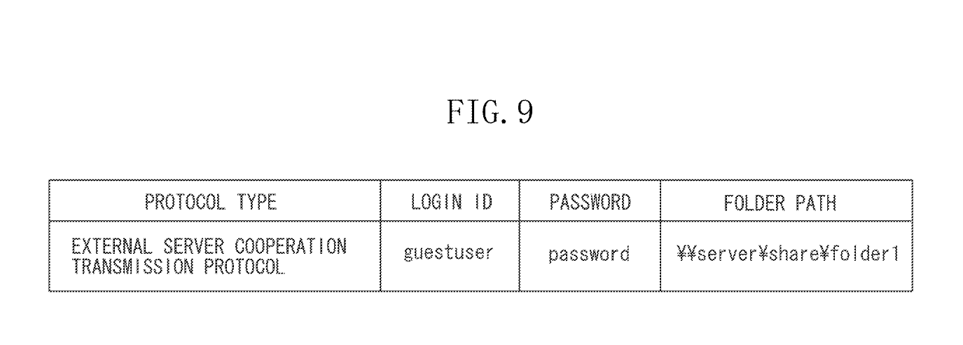

FIG. 9 illustrates an example of a table used by the common area management unit 603 to manage diversion target information. In the present exemplary embodiment, the common area management unit 603 manages the information pieces of a login ID, a password, and a folder path in association with a protocol type and a parameter name, as diversion target information.

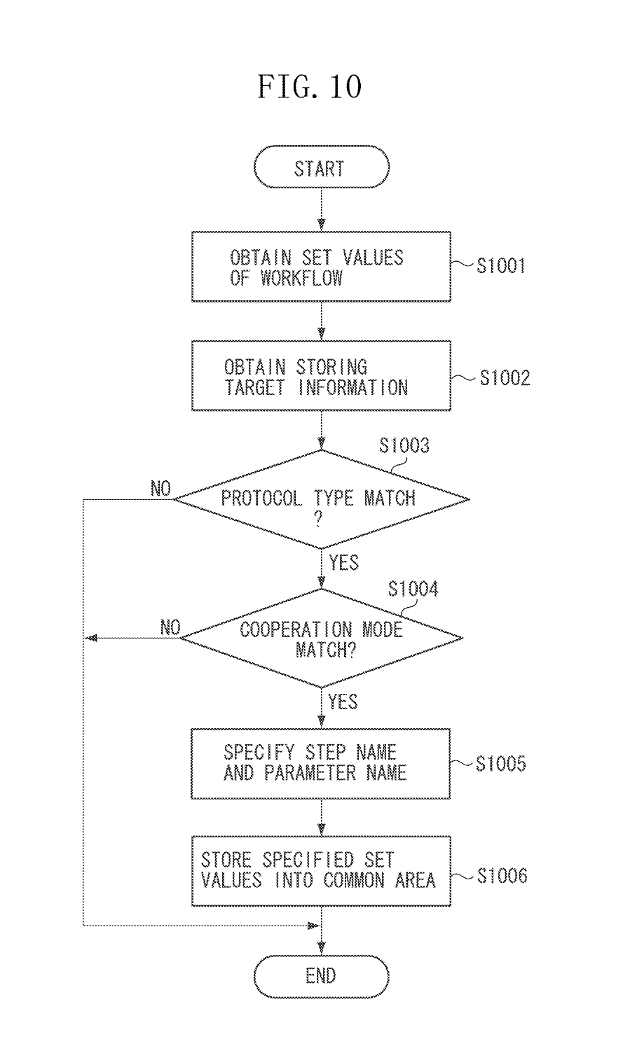

FIG. 10 illustrates an example of a flowchart for a process (storing process) in which the multifunction peripheral 101 stores set values of the workflow into the common area. For example, the multifunction peripheral 101 starts the storing process at an appropriate timing such as when a touch key on the screen for instructing start of the workflow is operated.

In step S1001, the control unit 607 obtains the set values of the workflow. More specifically, the control unit 607 specifies the workflow that is instructed to start, and calls the workflow analysis unit 605. The workflow analysis unit 605 analyzes the specified workflow, and returns the set values of the workflow to the control unit 607.

In step S1002, the control unit 607 obtains storing target information. More specifically, the control unit 607 calls the storing target information management unit 601 to obtain the storing target information. In step S1003, the control unit 607 determines whether the protocol type of the storing target information obtained in step S1002 matches the protocol type of the set values of the workflow obtained in step S1001. When determining that the types match (YES in step S1003), the control unit 607 performs processing in step S1004, and when determining that the types do not match (NO in step S1003), the control unit 607 ends the storing process.

In step S1004, the control unit 607 determines whether the cooperation mode of the storing target information obtained in step S1002 matches the cooperation mode of the set values of the workflow obtained in step S1001. When determining that the types match (YES in step S1004), the control unit 607 performs processing in step S1005, and when determining that the types do not match (NO in step S1004), the control unit 607 ends the storing process.

In step S1005, the control unit 607 calls the storing target information determination unit 602, and identifies targets (e.g., a step name and a parameter name) that match storing target information obtained in step S1002 from the set values of the workflow obtained in step S1001. In step S1006, the control unit 607 calls the common area management unit 603 to store the target values, which are identified in step S1005 from the set values of the workflow, into the common area in association with the protocol type and the parameter name. The control unit 607 then ends the storing process.

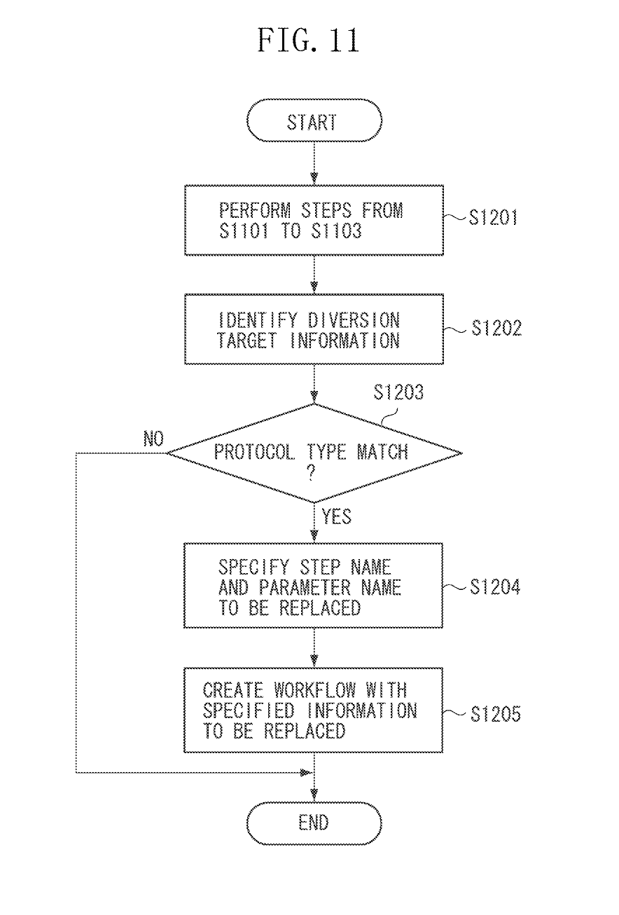

FIG. 11 illustrates an example of a flowchart for a process (creating process) in which the multifunction peripheral 101 creates a workflow. For example, the multifunction peripheral 101 starts the creating process at an appropriate timing such as when a touch key on the screen for instructing start of the workflow is operated. In step S1201, the control unit 607 performs a process (obtaining process) to obtain a list of diversion target information stored in the common area.

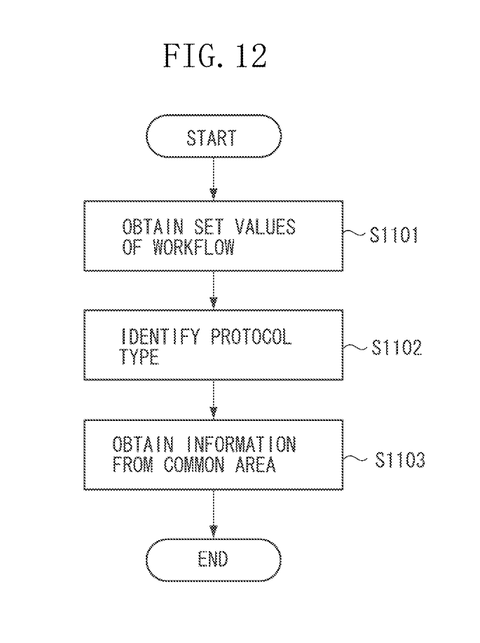

FIG. 12 illustrates an example of a flowchart for the obtaining process. In step S1101, the control unit 607 specifies the workflow that is instructed to start, and calls the workflow analysis unit 605. The workflow analysis unit 605 analyzes the specified workflow, and returns the set values of the workflow to the control unit 607.

In step S1102, the control unit 607 calls the workflow analysis unit 605 to identify a protocol type from the set values of the workflow. In step S1103, the control unit 607 specifies the identified protocol type, calls the common area management unit 603, and obtains a list of diversion target information stored in the common area. The control unit 607 then ends the obtaining process.

In step S1202, the control unit 607 identifies diversion target information from the list of diversion target information. The identification of diversion target information is performed by selecting pieces of the diversion target information in response to user operations from the list of diversion target information which is displayed on a screen in a selectable form.

In step S1203, the control unit 607 determines whether the protocol type of the diversion target information identified in step S1202 for diversion matches the protocol type of the set values of the workflow obtained in step S1101. When determining that the types match (YES in step S1203), the control unit 607 performs processing in step S1204, and when determining that the types do not match (NO in step S1203), the control unit 607 ends the creating process.

In step S1204, the control unit 607 calls the storing target information determination unit 602, and identifies information pieces of the step name and the parameter name of the workflow obtained in step S1101 which match the pieces of the diversion target information identified in step S1202 for diversion. The identified step name and the parameter name will be a step name and a parameter name of a replacing target.

The control unit 607 specifies the replacing target identified in step S1204, specifies the workflow instructed to start, and calls the workflow provision unit 606. In step S1205, the control unit 607 sets values of the workflow (i.e., creates the workflow) based on the identified replacing target via the workflow provision unit 606, and then ends the creating process.

The above process (setting of a workflow) are described with a specific example.

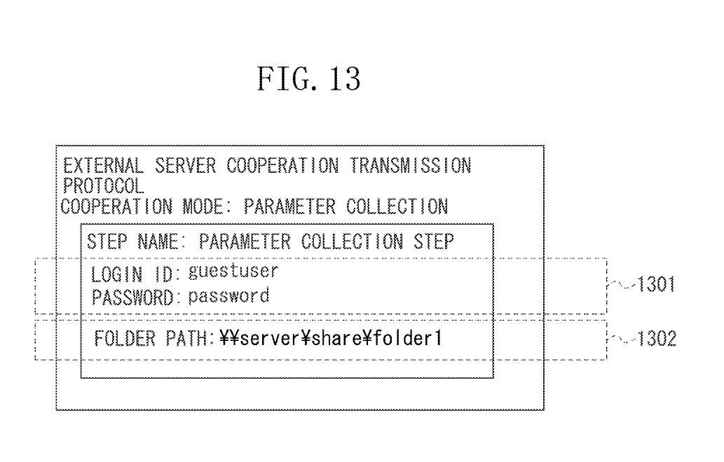

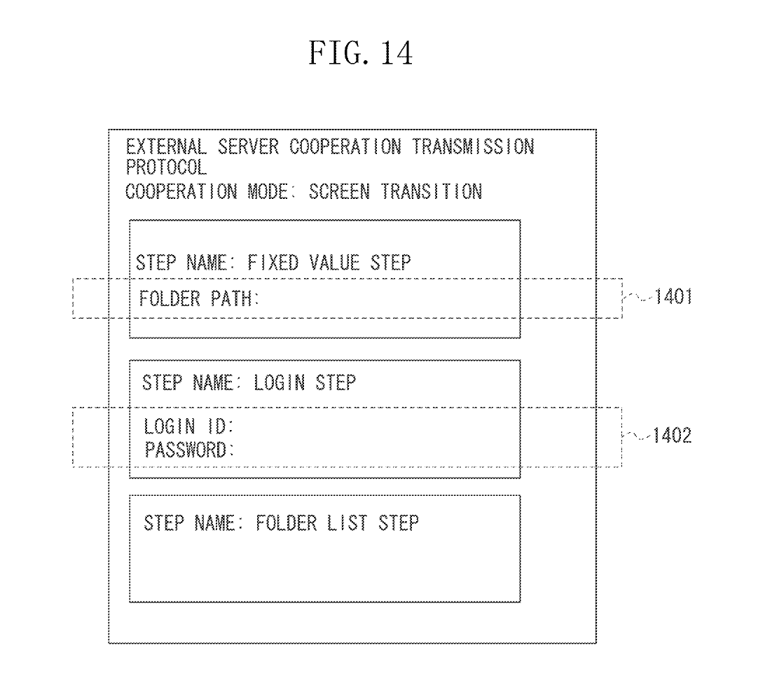

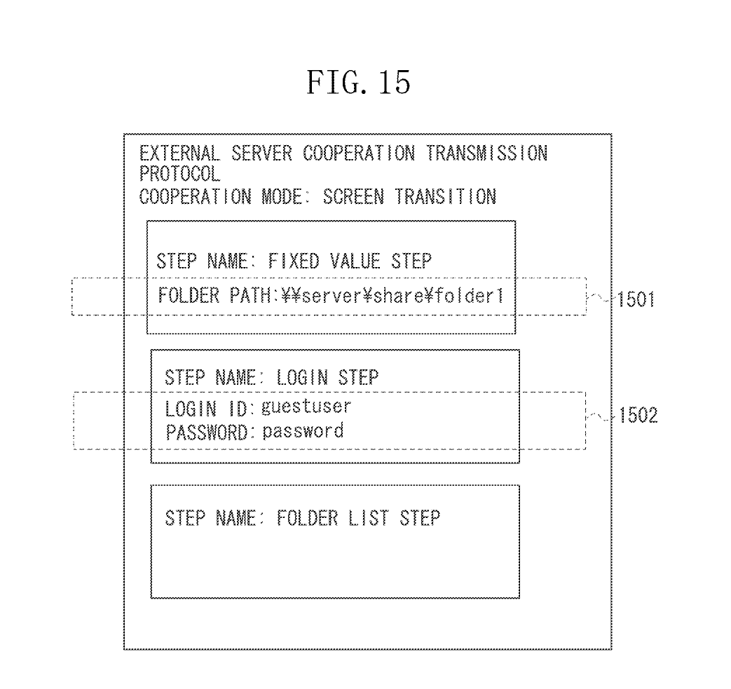

FIGS. 13, 14, and 15 each illustrate an example of a workflow in which an external server cooperation transmission protocol is used. FIGS. 13 and 14 each illustrate a workflow that is registered (created) in advance by a user. FIG. 15 illustrates a workflow that is created by applying the set values of the workflow in FIG. 13 to the workflow in FIG. 14 at implementation of the workflow in FIG. 14. At the implementation of the workflow in FIG. 14, a user applies a value of an item 1302 to an item 1401, and a value of an item 1301 to an item 1402. In other words, the applied values are the same, but have different formats according to the cooperation modes, so that the values need to be reset for each workflow to be implemented.

In the present exemplary embodiment, however, when the workflow in FIG. 13 is implemented, the storing process is performed and the set values of the workflow are stored in the common area, so that the set values of the workflow in FIG. 13 are reflected to the values of the workflow in FIG. 14. Accordingly, this can save the effort of input operations. It is assumed that the workflow in FIG. 14 does not have set values necessary for a process in the cooperation modes of the workflow.

A storing process at the implementation of the workflow in FIG. 13 by the controller unit 200 is described with a specific example. Upon the implementation of the workflow in FIG. 13, the storing process starts, and the control unit 607 specifies the workflow in FIG. 13 as a processing target. In step S1001, the control unit 607 obtains the set values of the workflow that are obtained by analysis of the specified workflow. The set values of the workflow are information pieces described in the workflow.

More specifically, the set values of the workflow include:

a protocol type “external server cooperation transmission protocol”;
a cooperation mode “parameter collection”;
a step name “parameter collection step”;
a parameter name (login ID) “guestuser”;
a parameter name (password) “password”; and
a parameter name (folder path) “¥¥server¥share¥folder1”.

In step S1002, the control unit 607 obtains the storing target information in FIG. 8. In step S1003, the control unit 607 compares the storing target information obtained in step S1002 with the set values obtained by the analysis in step S1001, and recognizes the match between the protocol type of the workflow and the external server cooperation transmission protocol. The process proceeds to step S1004. In step S1004, the control unit 607 compares the storing target information obtained in step S1002 with the set values obtained by the analysis in step S1001, and recognizes the match between the parameter collection cooperation modes. The process proceeds to step S1005.

In step S1005, the control unit 607 identifies storing targets from the storing target information in step S1002, based on the set values obtained by the analysis in step S1001. More specifically, the control unit 607 identifies the parameter name corresponding to the protocol type “external server cooperation transmission protocol” and the cooperation mode “parameter collection”, from among the storing target information pieces. In the present exemplary embodiment, the protocol type, the login ID, the password, and the folder path are identified as the storing target information pieces.

In step S1006, the control unit 607 stores the set values of the workflow, which are obtained in step S1001 and correspond to the targets identified in step S1005, into the common area. More specifically, the protocol type “external server cooperation transmission protocol”, the login ID “guestuser”, the password “password”, and the folder path “¥¥server¥share¥folder1” are stored in the common area.

The creating process to create the workflow in FIG. 15 using the workflow in FIG. 14 is described with a specific example. Upon the implementation of the workflow in FIG. 14, the creating process in FIG. 11 starts, and the control unit 607 identifies the workflow in FIG. 14 as a processing target. In step S1201, the control unit 607 performs an obtaining process (i.e., processes insteps from S1101 to S1103). In step S1101, the control unit 607 obtains the set values of the workflow obtained by the analysis of the workflow. The set values of the workflow are information pieces described in the workflow.

More specifically, the set values of the workflow include:

a protocol type “external server cooperation transmission protocol”;
a cooperation mode “screen transition”;
a step name “fixed value step”;
a parameter name (folder path) “(blank)”;
a step name “login step”;
a parameter name (login ID) “(blank)”;
a parameter name (password) “(blank)”; and
a step name “folder list step”.

In step S1102, the control unit 607 identifies the protocol type from the set values of the workflow. More specifically, the control unit 607 identifies the protocol type “external server cooperation transmission protocol”. In step S1103, the control unit 607 specifies the identified protocol type “external server cooperation transmission protocol”, calls the common area management unit 603, and obtains a list of diversion target information stored in the common area.

In the present exemplary embodiment, the list of the diversion target information contains:

a protocol type “external server cooperation transmission protocol”;
a parameter name (login ID) “guestuser”;
a parameter name (password) “password”; and
a parameter name (folder path) “¥¥server¥share¥folder1”.

In step S1202, the control unit 607 identifies the diversion target information for diversion. More specifically, the control unit 607 sets the information pieces specified by a user from the list displayed on a screen to be the diversion target information. In the present exemplary embodiment,

a protocol type “external server cooperation transmission protocol”;
a parameter name (login ID) “guestuser”;
a parameter name (password) “password”; and
a parameter name (folder path) “¥¥server¥share¥folder1” are identified as the diversion target information.

In step S1203, the control unit 607 recognizes that the protocol type “external server cooperation transmission protocol” of the diversion target information identified in step S1202 matches the protocol type “external server cooperation transmission protocol” that is one of the set values of the workflow obtained in step S1101. In step S1204, the control unit 607 identifies information pieces of the step name and the parameter name of the workflow obtained in step S1101 that match the diversion target information identified in step S1202, as replacing targets.

More specifically, for the parameter name (folder path) of the step name “fixed value step”, the parameter name (folder path) “¥¥server¥share¥folder1” is identified as the replacing target. For the parameter name (login ID) of the step name “login step”, the parameter name (login ID) “guestuser” is identified as the replacing target. For the parameter name (password) of the step name “login step”, the parameter name (password) “password” is identified as the replacing target.

In step S1205, the control unit 607 specifies the replacing targets identified in step S1204 and the workflow, calls the workflow provision unit 606, and creates a workflow that reflecting the identified replacing target information pieces. More specifically, the control unit 607 creates a workflow including the following set values:

a protocol type “external server cooperation transmission protocol”;
a cooperation mode “screen transition”;
a step name “fixed value step”;
a parameter name (folder path) “¥¥server¥share¥folder1”;
a step name “login step”;
a parameter name (login ID) “guestuser”; and
a parameter name (password) “password”.

According to the above configuration, initial values of the workflow can be selected from a list of diversion target information managed in the common area at implementation of the workflow, without the necessity of preset of the initial values, which can save the effort of input operations.

In a second exemplary embodiment, the multifunction peripheral 101 performs a storing process (i.e., processes in steps from S1001 to S1006) only when a workflow is successfully implemented. In other words, the storing process starts at the end of the process regarding the workflow. In the present exemplary embodiment, the same configurations as those in the first exemplary embodiment is designated with the same reference numerals, and is described only as needed.

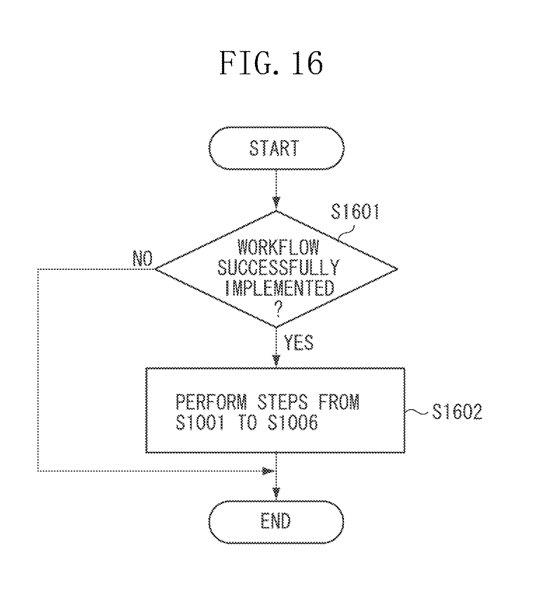

FIG. 16 illustrates an example of a flowchart for the storing process. In step S1601, the control unit 607 determines whether the workflow is successfully implemented. When determining the workflow is successfully implemented (YES in step S1601), the control unit 607 performs the process in step S1602. When determining the workflow is not successfully implemented (NO in step S1601), the control unit 607 ends the process. In step S1602, the control unit 607 performs the processes in steps from S1001 to S1006.

The workflow may be implemented throughout the entire processes for the workflow, or only through the process in the cooperation mode of the workflow. It is noted that the implementation of the processes in the cooperation mode of the workflow includes the parameter collection step, the fixed value step, and the login step. According to the above configuration, only the set values of the successfully implemented workflow are stored in the common area, which provides another advantage that the set values that are likely to contribute to successful implementation can be diverted.

In a third exemplary embodiment, the multifunction peripheral 101 manages diversion target information with security-related information thereof being blank. In the present exemplary embodiment, the same configurations as those in the first exemplary embodiment is designated with the same reference numerals, and is described only as needed.

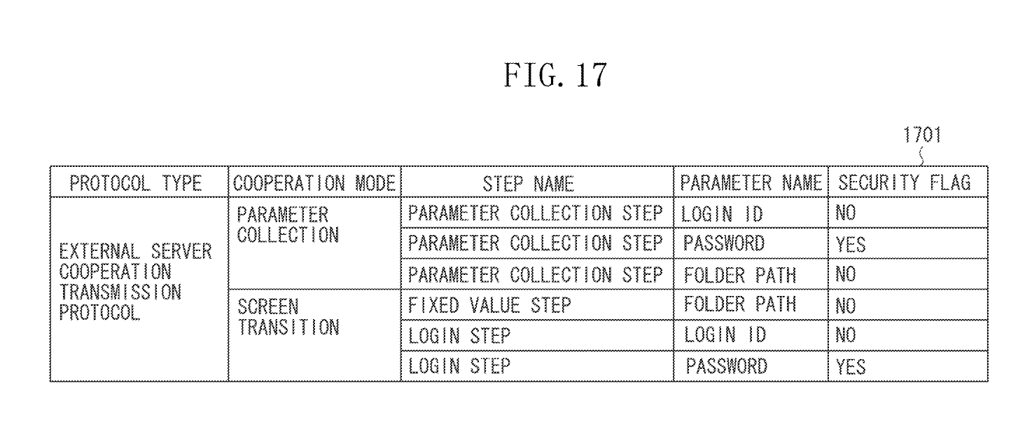

FIG. 17 illustrates an example of a table used by the storing target information management unit 601 to manage storing target information. The storing target information management unit 601 manages the information in a security flag item 1701 that is an example of determining information indicating whether parameter values are to be stored, as well as the information pieces in the items in FIG. 8. The information pieces having YES of the security flag (e.g., password) is the security-related information.

In other words, according to the present exemplary embodiment, in step S1005 in which the parameter of the storing target is identified, the control unit 607 does not identify the password item, or in step S1006 in which the set values are stored, the control unit 607 remains the password item blank. According to the above configuration, no security-related information is stored, which provides another advantage that security can be ensured.

In a forth exemplary embodiment, the multifunction peripheral 101 further manages information about workflow implementation date. In the present exemplary embodiment, the same configurations as those in the first exemplary embodiment is designated with the same reference numerals, and is described only as needed.

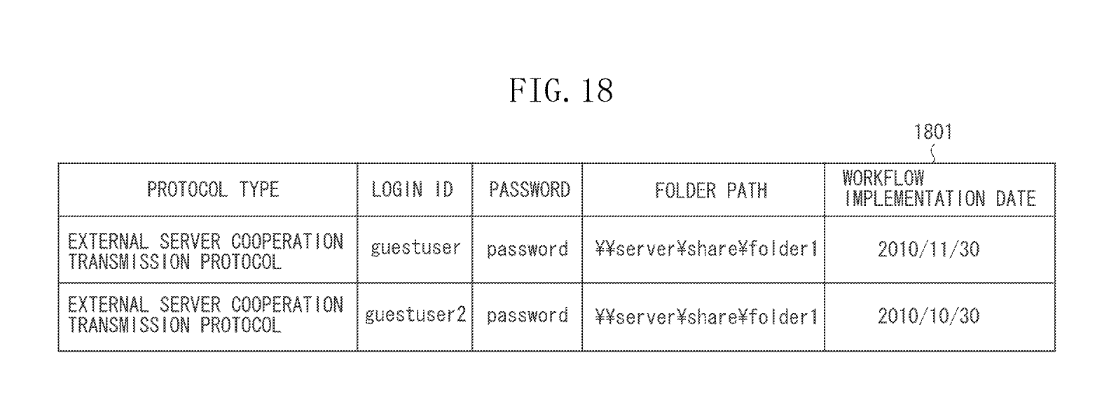

FIG. 18 illustrates an example of a table used by the common area management unit 603 to manage diversion target information. The common area management unit 603 manages the information in an item 1801 for the workflow implementation date in addition to the information pieces in the items in FIG. 9. For example, in step S1103 in which the list is obtained, the control unit 607 can obtain workflow implementation dates in descending order. In other words, according to the present exemplary embodiment, when the obtained list is displayed, the diversion target information pieces can be listed in the order of the implementation date of the workflow from the last to the first. According to the above configuration, the displayed list includes workflow information with workflow implementation dates in descending order, which can enhance convenience in selecting information from the list.

In a fifth exemplary embodiment, the multifunction peripheral 101 further manages the number of times a user selects diversion target information as a diversion target. In the present exemplary embodiment, the same configurations as those in the first exemplary embodiment is designated with the same reference numerals, and is described only as needed.

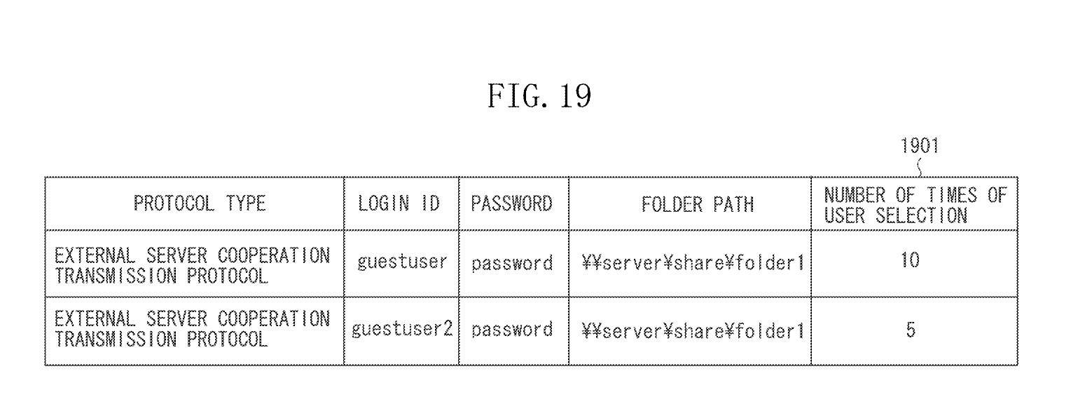

FIG. 19 illustrates an example of a table used by the common area management unit 603 to manage diversion target information. The common area management unit 603 manages the number of times the diversion target information is selected by a user as a diversion target in addition to the information pieces in the items in FIG. 9. For example, in step S1103 in which the list is obtained, the control unit 607 can obtain the number of times of workflow user selection 1901 in descending order. In other words, according to the present exemplary embodiment, when the obtained list is displayed, the diversion target information pieces can be listed in the descending order of frequency of use. According to the above configuration, the displayed list includes workflow information with the number of times of user selection in descending order, which can enhance convenience in selecting information from the list.

According to the configurations of the above exemplary embodiments, setting of parameter values of a workflow can be facilitated.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-072248 filed Mar. 29, 2011, which is hereby incorporated by reference herein in its entirety.

What is claimed is:

1. An information processing apparatus including a memory unit that stores a communication regulation for executing processing for a workflow in cooperation with a cooperation apparatus and definition information that includes definitions of parameters to be used in processing in each of process modes of the workflow, the information processing apparatus comprising:
a storage unit configured to store a parameter value corresponding to a parameter used in the processing in the process mode identified by the definition information in association with the parameter and information of the communication regulation as parameter information into the memory unit, from setting information of the workflow that includes the information of the communication regulation with the cooperation apparatus, information of the process modes of the workflow, parameters used in the processing in the process mode, and parameter values of the parameters; and
a setting unit configured to, when the workflow starts, read out parameter information in the information of the communication regulation that matches the information of the communication regulation in the setting information of the workflow from the memory unit, and to set a parameter value of the parameter information to a parameter of the setting information corresponding to the parameter of the read parameter information.

2. The information processing apparatus according to claim 1, wherein the storage unit determines whether the processing in the process mode of the workflow is completed, and stores the parameter value when the storage unit determines that the processing is completed.

3. The information processing apparatus according to claim 1, wherein the definition information further includes definition of determination information indicating whether a parameter value is stored or not corresponding to each of the parameters, and
wherein, when determining that the determination information of the identified parameter indicates not to be stored, the storage unit does not store a parameter value of the parameter.

4. The information processing apparatus according to claim 1, wherein the setting unit, when reading out a plurality of pieces of the parameter information from the memory unit, displays the plurality of pieces of the parameter information in a selectable form on a screen, and sets a parameter value of the parameter information to the parameter of the setting information that corresponds to a parameter of the parameter information selected in response to a user operation.

5. The information processing apparatus according to claim 4, wherein the storage unit further stores information of date when the processing of the workflow is implemented in association with the parameter information, and
wherein the setting unit displays the plurality of pieces of the parameter information in a selectable form on a screen in descending order of the date based on the date information.

6. The information processing apparatus according to claim 4, wherein the storage unit stores information of a number of times that the parameter information is selected in response to a user operation into the memory unit, and
wherein the setting unit displays the plurality of pieces of the parameter information in a selectable form on a screen in descending order of the number of times based on the information of the number of times.

7. A method for setting a workflow in an information processing apparatus including a memory unit that stores a communication regulation for executing processing for a workflow in cooperation with a cooperation apparatus and definition information that includes definitions of parameters to be used in processing in each of process modes of the workflow, the method comprising:
storing a parameter value corresponding to a parameter used in the processing in the process mode identified by the definition information in association with the parameter and information of the communication regulation as parameter information into the memory unit, from setting information of the workflow that includes the information of the communication regulation with the cooperation apparatus, information of the process modes of the workflow, parameters used in the processing in the process mode, and parameter values of the parameters; and
reading out parameter information, at a start of the workflow, in the information of the communication regulation that matches the information of the communication regulation in the setting information of the workflow from the memory unit, and setting a parameter value of the parameter information to a parameter of the setting information corresponding to the parameter of the read parameter information.

8. A computer-readable storage medium storing a communication regulation, which when loaded into a computer and executed performs a method for setting a workflow in an information processing apparatus for executing processing for a workflow in cooperation with a cooperation apparatus and definition information that includes definitions of parameters to be used in processing in each of process modes of the workflow, the method comprising:
storing a parameter value corresponding to a parameter used in the processing in the process mode identified by the definition information in association with the parameter and information of the communication regulation as parameter information into the memory unit, from setting information of the workflow that includes the information of the communication regulation with the cooperation apparatus, information of the process modes of the workflow, parameters used in the processing in the process mode, and parameter values of the parameters; and
reading out parameter information, at a start of the workflow, in the information of the communication regulation that matches the information of the communication regulation in the setting information of the workflow from the memory unit, and setting a parameter value of the parameter information to a parameter of the setting information corresponding to the parameter of the read parameter information.
